(19) United States
(12) Patent Application Publication
(10) Pub. No.: US 2016/0098886 A1
(43) Pub. Date: Apr. 7, 2016

(54) ELECTRONIC CONTAINER VENDING METHOD

(71) Applicant: Air Liquide Advanced Technologies U.S. LLC, Houston, TX (US)

(72) Inventors: Joshua LAVRA, Walnut Creek, CA (US); Giuseppe Liberati, Houston, TX (US)

(21) Appl. No.: 14/508,278

(22) Filed: Oct. 7, 2014

(51) Int. Cl. G07F 11/00; G06Q 10/08; G06Q 20/14

(52) U.S. Cl. CPC G07F 11/007; G06Q 20/14; G06Q 10/087

(57) ABSTRACT

A method of acquiring gas containers from an electronic container vending machine is presented. This method includes receiving an input from a user by means of an input device, indicating a desired gas container of a specific size and containing a specific gas composition. Then determining the availability of the desired gas container with an electronic container inventory means. Then indicating the availability of the desired gas container to the user by means of an output means. Then receiving a user payment to an electronic payment interface. A discount or promotional value may be accepted via QR reader interface. Then delivering the desired gas container through an access permission means, thereby rotating a rotatable container storage and dispensing unit to a predetermined position, and switching an access means from a locked state and an unlocked state.

### Background

The present invention relates generally to vending and dispensing machines and in particular to such a machine for vending a compressed gas cylinders, such as those used in welding.

Standard pressurized gas cylinders, such as the type typically used for shielding gas for welding and for cutting, pose vending problems. These cylinders have a cylindrically shaped tank, a valve at the top of the tank, and a guard substantially encircling the valve and providing a pair of lifting handles. The guard typically has a diameter smaller than the diameter of the outer surface of the tank. These standard cylinders can be relatively heavy, at least 20 pounds, possibly as heavy as 50 pounds.

It is the common practice for an individual, or small business, to acquire or exchange such pressurized gas cylinders at a store front. This can be inconvenient if the demand arises when the store is not open. Therefore, there is a need in the industry for a means for such small quantity users to obtain such cylinders around the clock, in a convenient and secure manner.

### SUMMARY

A method of acquiring gas containers from an electronic container vending machine is presented. This method includes receiving an input from a user by means of an input device, indicating a desired gas container of a specific size and containing a specific gas composition. Then determining the availability of the desired gas container with an electronic container inventory means. Then indicating the availability of the desired gas container to the user by means of an output means. Then receiving a user payment to an electronic payment interface. A discount or promotional value may be accepted via QR reader interface. Then delivering the desired gas container through an access permission means, thereby rotating a rotatable container storage and dispensing unit to a predetermined position, and switching an access means from a locked state and an unlocked state.

### DETAILED DESCRIPTION

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

One embodiment of the present invention is a method of acquiring gas containers from an electronic container vending machine. This method includes receiving an input from a user by means of an input device, indicating a desired gas container of a specific size and containing a specific gas composition. Then determining the availability of the desired gas container with an electronic container inventory means. Then indicating the availability of the desired gas container to the user by means of an output means. Then receiving a user payment to an electronic payment interface. A discount or promotional value may be accepted via QR reader interface. Then delivering the desired gas container through an access permission means, thereby rotating a rotatable container storage and dispensing unit to a predetermined position, and switching an access means from a locked state and an unlocked state.

The rotatable container storage and dispensing unit may be capable of incrementally rotating and locking in predetermined positions, including multiple discrete storage volumes each configured to contain a single container.

The input device may include an electronic selection means configured to allow the acquisition or return of a container, comprising an electronic control means for rotating and locking the rotatable container storage and dispensing unit, and an electronic control means for locking and unlocking the access means.

The electronic selection device may include a multi-touch screen display.

The electronic container inventory means may be configured to indicate a quantity of available containers, and a quantity of unoccupied storage volumes.

The electronic container inventory means may include RFID tags on the available containers. The electronic container inventory means may include a QR code reader.

The electronic payment interface may be configured to allow for payments or refunds. The electronic payment interface may include a credit card payment interface. The electronic payment interface may include an NFC payment interface.

The access permission means may be configured to rotate the rotatable container storage and dispensing unit to a predetermined position, and allow access to a discrete storage volume by modulating the access means.

In one embodiment of the present invention, one module may house oxygen and other inert gases, while a different module may house acetylene, other combustible gases, and inert gases. The module with the acetylene may be equipped with a lower explosive limit (LEL) meter.

The modules may have provisions for monitoring temperatures and thereby activating ventilation fans under conditions of high ambient or module internal temperatures. Safety alarms may be generated by the system.

What is claimed is:

1. A method of acquiring gas containers from an electronic container vending machine, comprising;
providing an electronic container vending machine;
receiving an input from a user by means of an input device, indicating a desired gas container of a specific size and containing a specific gas composition,
determining the availability of said desired gas container with an electronic container inventory means,
indicating the availability of said desired gas container to said user by means of an output means,
receiving a user payment to an electronic payment interface,
accepting discount or promotional value via QR reader interface,
delivering said desired gas container through an access permission means, thereby rotating a rotatable container storage and dispensing unit to a predetermined position, and switching an access means from a locked state and an unlocked state.

2. The method of claim 1, wherein said rotatable container storage and dispensing unit is capable of incrementally rotating and locking in predetermined positions, comprising multiple discrete storage volumes each configured to contain a single container,

3. The method of claim 1, wherein said input device comprises, an electronic selection means configured to allow the acquisition or return of a container, comprising an electronic control means for rotating and locking said rotatable container storage and dispensing unit, and an electronic control means for locking and unlocking said access means.

4. The method of claim 3, wherein said electronic selection device comprises a multi-touch screen display.

5. The method of claim 1, wherein said electronic container inventory means is configured to indicate a quantity of available containers, and a quantity of unoccupied storage volumes,

6. The electronic container vending machine of claim 4, wherein said electronic container inventory means comprises RFID tags on the available containers.

7. The electronic container vending machine of claim 4, wherein said electronic container inventory means comprises a QR code reader.

8. The method of claim 1, wherein said electronic payment interface is configured to allow for payments or refunds.

9. The electronic container vending machine of claim 8, wherein said electronic payment interface comprises a credit card payment interface.

10. The electronic container vending machine of claim 5, wherein said electronic payment interface comprises an NFC payment interface.

11. The method of claim 1, wherein said access permission means is configured to rotate said rotatable container storage and dispensing unit to a predetermined position, and allow access to a discrete storage volume by modulating said access means.

12. The electronic container vending machine of claim 1, wherein the container is a compressed gas cylinder.

13. The electronic container vending machine of claim 12, wherein the compressed gas cylinder contains a welding gas mixture.

14. The electronic container vending machine of claim 13, wherein the welding gas mixture is selected from the group consisting of argon, carbon dioxide, oxygen, helium, nitrogen, or mixtures thereof.

15. The electronic container vending machine of claim 12, wherein the compressed gas cylinder contains acetylene.
